(19) United States
(12) Patent Application Publication
(10) Pub. No.: US 2020/0098176 A1
(43) Pub. Date: Mar. 26, 2020

(54) IMMERSIVE SHOPPING SYSTEMS, DEVICES, AND METHOD

(71) Applicant: NEXTREV COMMERCE LLC, NEW YORK,, NY (US)

(72) Inventors: SERGE KASSARDJIAN, NEW YORK, NY (US); NEIL COLE, NEW YORK, NY (US)

(73) Assignee: NEXTREV COMMERCE LLC, NEW YORK,, NY (US)

(21) Appl. No.: 16/580,457

(22) Filed: Sep. 24, 2019

Related U.S. Application Data
(60) Provisional application No. 62/735,255, filed on Sep. 24, 2018.

(51) Int. Cl. G06T 19/00; G06Q 30/06

(52) U.S. Cl. CPC G06T 19/003; G06Q 30/0643; G06T 19/006; G06Q 30/0639; G06Q 30/0613

(57) ABSTRACT

A system and a method for implementing an immersive experience may include capturing a plurality of images; generating a navigable space based on the images, the navigable space being an immersive shopping experience, the immersive shopping experience having a floor plan including a plurality of locations; associating one or more items for sale that are also on sale on a merchant e-commerce website with at least one of the plurality of locations; presenting the immersive shopping experience to a user computer through the merchant e-commerce website from a third party server; receiving a user request to purchase at least one of the one or more items that is generated in the immersive shopping experience sent to the third party server from the user computer; and updating a shopping cart via communication between the third party server and the merchant e-commerce website, the updating of the shopping cart occurring in real-time.

### CROSS REFERENCE TO RELATED APPLICATIONS

This application claims priority to and the benefit of U.S. Prov. Pat. App Ser. 62/735,255, which was filed on Sep. 24, 2018, the entire contents of which are hereby incorporated herein by reference.

### FIGURE SELECTED FOR PUBLICATION

FIG. 1

### BACKGROUND

### Technical Field

The present disclosure relates generally to systems, devices, and methods relating to immersive experiences (e.g., a simulation, virtual reality and/or augmented reality), and more particularly to immersive experiences that facilitates e-commerce.

### Description of the Related Art

An immersive experience may refer to experiences in which a user interacts with an experience either to simulate real world activities (e.g., a simulation or virtual reality) or to enhance those activities (e.g., augmented reality) in a represented experience. Generally, the terms ‘immersion’ or ‘immersive’ refers to a perception of being physically present in a non-physical world. When used in this application, however, the terms ‘immersion’ or ‘immersive’ when referring to ‘experiences’ refer to both activities that might be entirely or only partially simulated whether or not the user is physically present in the represented experience. For example, as used herein, the term ‘immersive experience’ may also or alternatively refer to a simulation that provides a three-dimensional computer graphics that use a three-dimensional representation of geometric data on a conventional two-dimensional computer monitor or smartphone provided that a user can navigate through the simulated representation of the experience (e.g., an actual or imaginary physical shopping mall or store).

Increasingly, immersive experiences have been created to mimic the reality of a variety of experiences ranging from sports to travel. However, one area that that is lacking is providing platforms that provide immersive experiences for e-commerce. One challenge is replicating a real-world retail location as an immersive experience experience in which users may browse items that are for sale and purchase those items without leaving the immersive experience. Conventional immersive experience and e-commerce platforms would not be capable of being integrated such that a user can seamlessly select an item in the immersive experience and have that item added to the shopping cart of the e-commerce platform. Rather, conventionally, a user would only be able to identify an item she would like to purchase while in the immersive experience and then the user would be redirected to a separate e-commerce site to once again locate that item for sale and to finalize the transaction. It would be advantageous to provide an integrated solution in which a user may remain in an immersive experience, select items, and purchase those items from within the immersive experience. This is one of the challenges and problems that the present disclosure addresses by providing a solution for such seamless integration.

It is to be understood that the above background section is merely illustrative to understand some of the problems addressed by the present disclosure and should not be construed as being an admission of prior art.

### SUMMARY

The present disclosure relates to a computer-implemented method including: capturing a plurality of images; generating a navigable space based on the plurality of images, the navigable space being an immersive shopping experience, the immersive shopping experience having a floor plan including a plurality of locations; associating one or more items for sale with at least one of the plurality of locations, the one or more items for sale being for sale on a merchant e-commerce website; presenting the immersive shopping experience to a user computer through the merchant e-commerce website from a third party server; receiving a user request to purchase at least one of the one or more items, the user request being generated from within the immersive shopping experience, the request being sent to the third party server from the user computer; and updating a shopping cart on the merchant e-commerce website via communication between the third party server and the merchant e-commerce website, the updating of the shopping cart occurring in real-time with the generation of the user request from via the immersive shopping experience.

Each of the plurality of locations may have a three-dimensional coordinate including an x-axis coordinate, a y-axis coordinate, and a z-axis coordinate. The plurality of locations may include a first location and a second location, the x-axis and y-axis coordinates of the first and second locations being the same and the z-axis coordinates of the first and second locations being different.

Also disclosed is a computer system for implementing an immersive shopping experience that includes: a processor; a tangible, non-transitory method configured to communicate with the processor, the tangible, non-transitory memory having instructions stored thereon that, in response to execution by the processor, cause the processor to perform operations of the above described method.

The above and other aspects, features and advantages of the present disclosure will become apparent from the following description read in conjunction with the accompanying drawings, in which like reference numerals designate the same elements.

### BRIEF DESCRIPTION OF THE DRAWINGS

A further understanding of the present disclosure can be obtained by reference to a preferred embodiment set forth in the illustrations of the accompanying drawings. Although the illustrated preferred embodiment is merely exemplary of methods, structures and compositions for carrying out the present disclosure, both the organization and method of the disclosure, in general, together with further objectives and advantages thereof, may be more easily understood by reference to the drawings and the following description. The drawings are not intended to limit the scope of this disclosure, which is set forth with particularity in the claims as appended or as subsequently amended, but merely to clarify and exemplify the disclosure.

For a more complete understanding of the present disclosure, reference is now made to the following drawings in which:

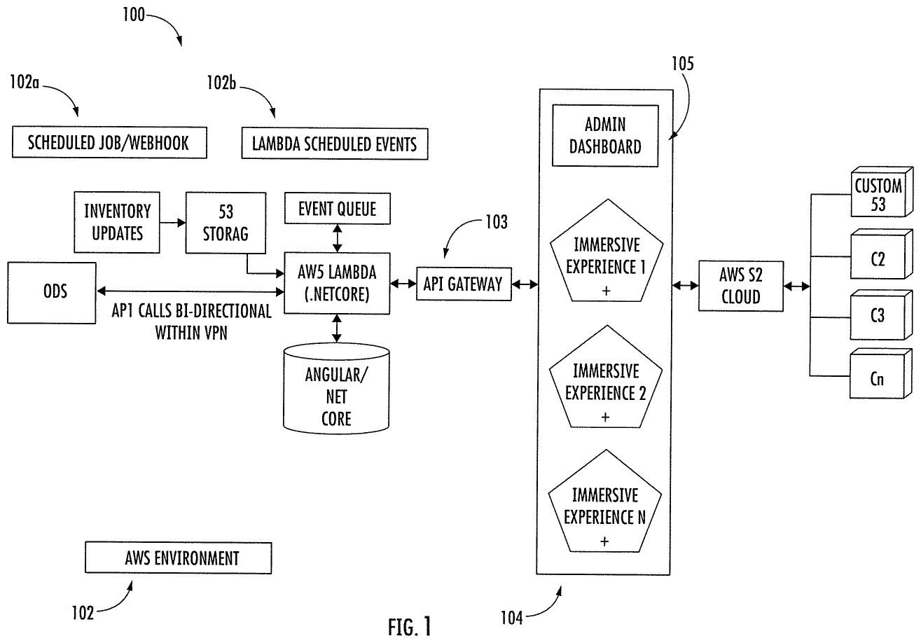

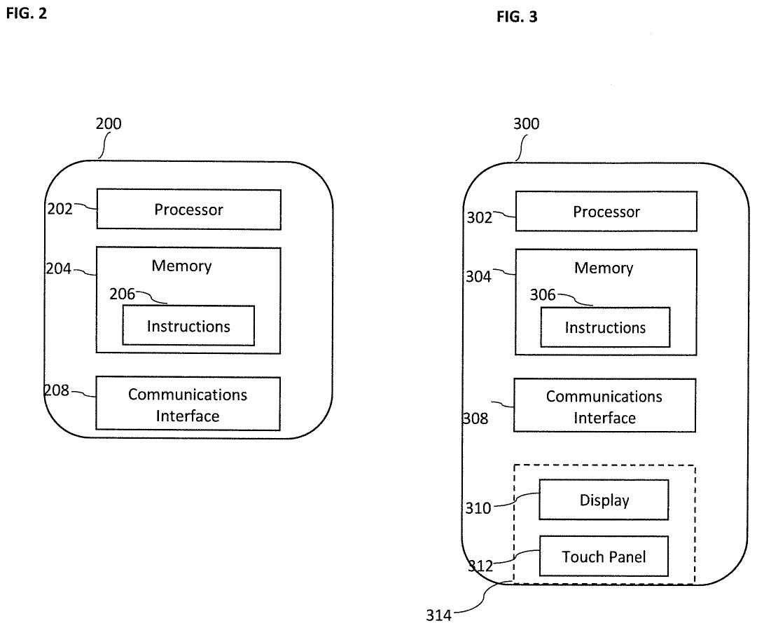

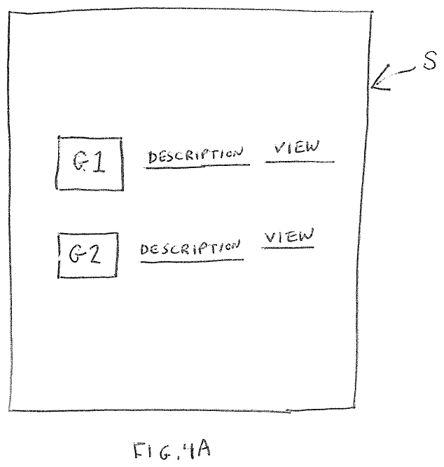

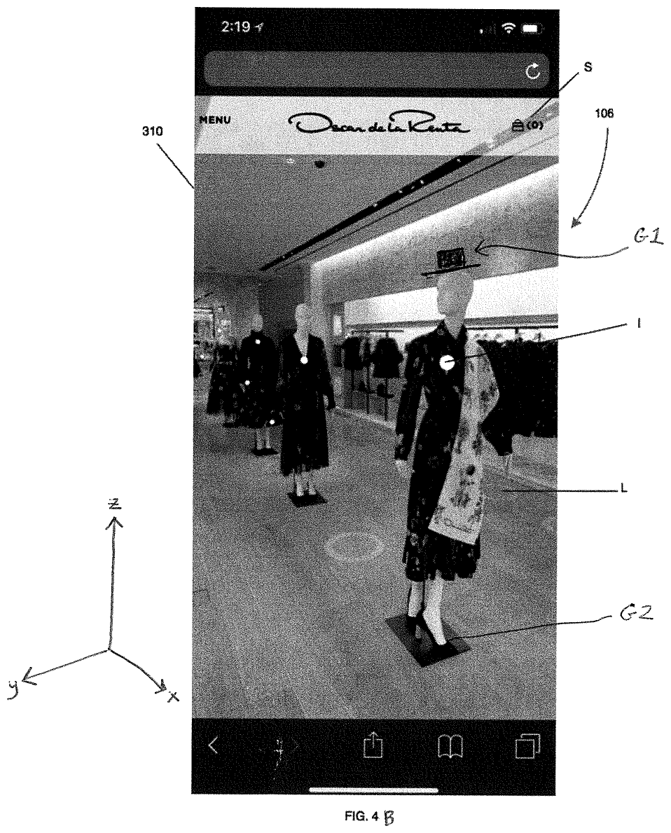

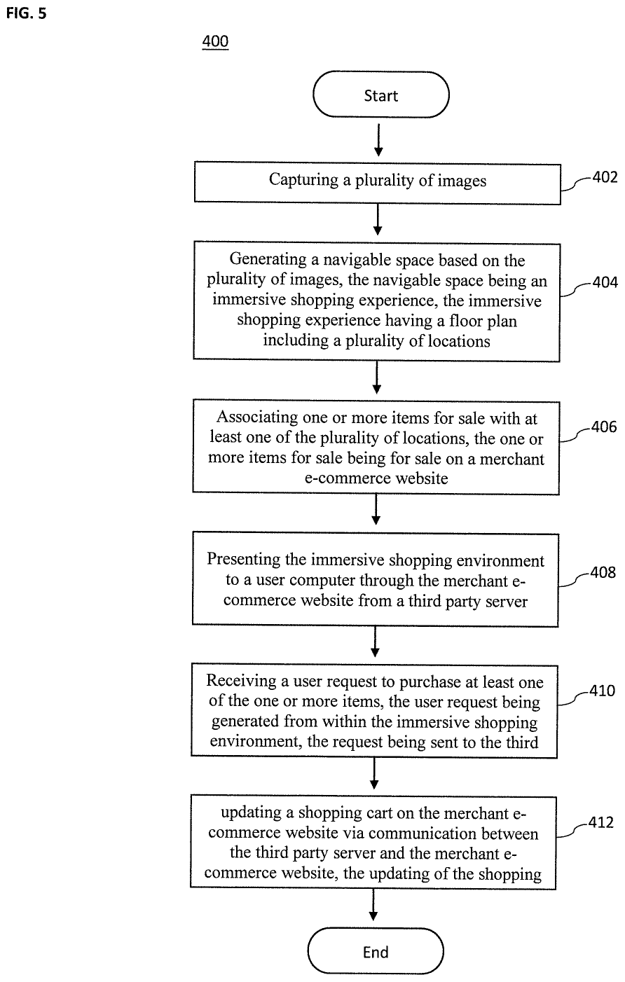

FIG. 1 is a schematic illustration of a system in accordance with the present disclosure.

FIG. 2 depicts a diagram of an embodiment of a server according to aspects of the disclosure;

FIG. 3 depicts a diagram of an embodiment of a user device according to aspects of the present disclosure;

FIG. 4A is a view of a user interface including a virtual shopping cart.

FIG. 4B is an illustration of a user interface or immersive store as displayed on a display of the user device of FIG. 3.

FIG. 5 is a flowchart illustrating a method according to aspects of the present disclosure.

### DETAILED DESCRIPTION

As required, a detailed illustrative embodiment of the present disclosure is disclosed herein. However, techniques, systems, compositions and operating structures in accordance with the present disclosure may be embodied in a wide variety of sizes, shapes, forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the present disclosure.

Reference will now be made in detail to several embodiments of the disclosure that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, below, etc., or motional terms, such as forward, back, sideways, transverse, etc. may be used with respect to the drawings. These and similar directional terms should not be construed to limit the scope of the disclosure in any manner.

As will be described with reference to the accompanying figures, an immersive e-commerce system 100 for implementing an immersive shopping experience will now be described. As discussed above, the immersive e-commerce system 100 and the methods described herein provide a novel tool for seamlessly enabling a user or consumer to make purchases on an existing merchant e-commerce surface (e.g., website, app or any other online tool used to sell products) in a seamless manner. That is, selection of an item to be purchased can be added to a shopping cart within an existing shopping cart of an existing e-commerce website without all from within the immersive experience without requiring the performance of additional steps.

As shown in FIG. 1, the immersive e-commerce system 100 may include a hosting service 102 such as, for example, AMAZON WEB SERVICES (AWS) or the like on which a merchant's e-commerce or point of sale (POS) site may be hosted. The AWS Management Console, you can create an API that acts as a “front door” for applications or jobs 102a to access data, business logic, or functionality from your back-end services, such as workloads running on Amazon Elastic Compute Cloud (Amazon EC2), code running on, for example, AWS Lambda 102b, or any web application. In an embodiment, existing ecommerce APIs may be utilized to create the cart and checkout process to confirmation. However, other means of integrating the cart and checkout process may be utilized. For example, the system 100 may interface with backend data with our immersive stores via custom APIs.

To minimize API calls to other third-party systems like MAGENTO and SHOPIFY, for example, the API calls may be bundled as much as possible and only call methods when required. As used herein, the term ‘third party’ may also refer to as systems or sites that are not hosted by the Merchant or the user (i.e., shopper or customer). That is, other parties other than the merchant and the customer may be involved. API calls such as those provided by SHOPIFY or similar platforms may include, for example, checkout API calls, generating checkout, getting a shipping rate, setting a shipping rate, getting a vault ID for credit card information, and executing the transaction. although the system 100 is shown and described as including the hosting service 102, in some embodiments, the merchant e-commerce surface or point of sale may not be hosted on the e-commerce system 100 itself, but rather the system 100 may include servers that communicate with the merchant e-commerce surface and/or its associated hosting service, e.g., hosting service 102.

As shown in FIG. 1, an APS gateway 103 may link and integrate the existing AWS experience 102 with an administrative dashboard module 104 may include a plurality of immersive experiences that may be selected by a merchant which may be uploaded to a cloud based server (AWS 52 Cloud) associated with the existing AWS experience. The integration of the administrative dashboard module 104 and its immersive experiences 105 may be streamed to user devices (e.g., computer or smartphone) as customized immersive stores or experiences 106 that are presented to the user, e.g., via a display of a smartphone or a Virtual Reality headset or the like. Conventionally, API calls such as those described above would have necessitated the customer to effect such API calls directly on the merchant's e-commerce site and to the extent any immersive experience may have existed, such immersive experience would provide no functionality other than a preview of items available for sale. Advantageously, the immersive experience system 100 facilitates such API calls to be performed via the immersive experience, thereby providing a true e-commerce experience in which items can be added to a shopping cart and/or completing a shopping transaction or purchase.

The administrative dashboard module 104 may be provided by a server 200 (FIG. 2) that may be any suitable type of computing device (or system) that is capable of directly or indirectly communicating with the client devices 300 via a communications network. The servers 200 may also be capable of directly or indirectly communicating with the existing e-commerce site or in some embodiments with a database that lists current items that are for sale by the merchant. In some embodiments, any of the servers 200 may include a web server that is capable of communicating with client devices 300 and/or items database via the communications network, such that the servers 200 use the communication network 102 to transmit and display information on a display 310 of a client device 300. As described in more detail above, a plurality of servers 200 may comprise a server system (e.g., a load-balanced server farm), in which the servers 200 communicate directly or indirectly over a network and exchange information for the purpose of receiving, processing, and transmitting data to at least one of the client devices 300. It is further understood that a greater or lesser number of such servers 200 may be included in the navigation system 100.

According to aspects of the disclosure, the client devices 300 may include any suitable type of computing device (or system) that is capable of directly or indirectly communicating with the server system via the communications network. The client devices 300 may also be capable of directly or indirectly communicating with the external item database 105. For example, any of the client devices 300 may include a smartphone, a smartwatch, a tablet, a laptop, a desktop computer, a fitness or activity tracker, a global positioning system (GPS) device, a smart vehicle, a digital media player, a wearable technology device, or any mobile device capable of exchanging data with the server system 101 via the communications network 102. It is further understood that a greater or lesser number of such client devices 300 may be included in the navigation system 100.

According to aspects of the disclosure, the communications network 102 may include, but is not limited to, one or more of the Internet, World Wide Web, intranets, virtual private networks (VNPs), wide area networks (WANs), local networks (LANs), private networks using communication protocols proprietary to one or more companies, Ethernet, WiFi (such as 802.11 standards), BLUETOOTH, wireless telecommunications networks (e.g., LTE, 4G, 3G), HTTP, and various combinations and configurations of the foregoing.

With reference to FIG. 2, a diagram is depicted of an embodiment of a server 200, according to aspects of the disclosure. As illustrated, the server 200 may include a processor 202, a memory 204, and/or a communications interface 208. According to aspects of the disclosure, the processor 202 may include any suitable type of processing circuitry, such as a general-purpose processor (e.g., an ARM-based processor), an application-specific integrated circuit (ASIC), or a Field-Programmable Gate Array (FPGA). The memory 204 may include any suitable type of volatile and non-volatile memory capable of storing information accessible by the processor 202, such as random-access memory (RAM), read-only memory (ROM), a hard disk (HD), a solid state drive (SSD), a CD-ROM, flash memory, cloud storage, and network accessible storage (NAS). The communications interface 208 may include any suitable type of communications interface, such as a WiFi interface, an Ethernet interface, a Long-Term Evolution (LTE) interface, an Infrared interface, a BLUETOOTH Interface, the like, and/or any combination thereof.

The memory 204 stores information accessible by the processor 202, including instructions 206 that may be executed by the processor. The instructions 206 may be any set of instructions to be executed directly (such as machine code) or indirectly (such as scripts) by the processor. In that regard, the terms “instructions,” “steps,” and “programs” may be used interchangeably herein. The instructions 206 may be stored in object code format for direct processing by the processor 202, or in any other computer language including scripts or collections of independent source code modules that are interpreted on demand or compiled in advance. The instructions 206 may include functions, methods, routines, the like, and/or any combination thereof.

Although FIG. 2 functionally illustrates the processor 202 and the memory 204 as being within the same block, it will be understood by those of ordinary skill in the art that the processor 202 and the memory 204 may actually comprise multiple processors and multiple memories that may or may not be stored within the same physical housing. Further, some or all of the instructions 206 may be stored in a location physically remote from, yet still accessible by, the processor 202. For example, some of the instructions 206 may be stored within a read-only computer memory chip and others on removable CD-ROM. Similarly, the processor 202 may include a collection of processors that may or may not operate in parallel or that may be part of the same cloud computing system.

With reference to FIG. 3, a diagram is depicted of an embodiment of a client device 300, according to aspects of the disclosure. As illustrated, the client device 300 may include a processor 302, a memory 304, a communications interface 308, a display 310, and/or a touch panel 312. According to aspects of the disclosure, the processor 302 may include any suitable type of processing circuitry, such as a general-purpose processor (e.g., an ARM-based processor), an application-specific integrated circuit (ASIC), or a Field-Programmable Gate Array (FPGA). The memory 304 may include any suitable type of volatile and non-volatile memory capable of storing information accessible by the processor 302, such as random-access memory (RAM), read-only memory (ROM), a hard disk (HD), a solid state drive (SSD), a CD-ROM, flash memory, cloud storage, and network accessible storage (NAS). The communications interface 308 may include any suitable type of communications interface, such as a WiFi interface, an Ethernet interface, a Long-Term Evolution (LTE) interface, an Infrared interface, a BLUETOOTH Interface, the like, and/or any combination thereof.

The display 310 of client device 300 may include any suitable type of display such as a liquid crystal display (LCD), a light-emitting diode (LED) display, or an active-matrix organic light-emitting diode (AMOLED) display. The touch panel 312 may include any suitable type of touch panel, such as a capacitive touch panel or a resistive touch panel. In some embodiments, the touch panel 312 may be layered onto the display 310 to form a touchscreen 314. Although not illustrated, the client device 300 may include additional or alternative input devices, such as a microphone, a keyboard, and a mouse.

The memory 304 stores information accessible by the processor 302, including instructions 306 that may be executed by the processor. The instructions 306 may be any set of instructions to be executed directly (such as machine code) or indirectly (such as scripts) by the processor. In that regard, the terms “instructions,” “steps” and “programs” may be used interchangeably herein. The instructions 306 may be stored in object code format for direct processing by the processor 302, or in any other computer language including scripts or collections of independent source code modules that are interpreted on demand or compiled in advance. The instructions 206 may include functions, methods, routines, the like, and/or any combination thereof

Although FIG. 3 functionally illustrates the processor 302 and the memory 304 as being within the same block, it will be understood by those of ordinary skill in the art that the processor 302 and the memory 304 may actually comprise multiple processors and multiple memories that may or may not be stored within the same physical housing. Further, some or all of the instructions 306 may be stored in a location physically remote from, yet still accessible by, the processor 302. For example, some of the instructions 306 may be stored within a read-only computer memory chip and others on removable CD-ROM. Similarly, the processor 302 may actually comprise a collection of processors that may or may not operate in parallel or that may be part of the same cloud computing system.

As shown in FIG. 4A, a user interface is shown that includes a shopping cart C that may display one or more items G1 and G2. When an item G1 or G2 is selected by a user, the immersive store or experience 106, shown in FIG. 4B, may be displayed to display the selected item. For example, when item G1 is selected, the item G1 may be displayed within the immersive store or experience 106. Advantageously, not only can an item G1 be located on a two-dimensional (2D) floorplan, but the item G1 can also be located within a three-dimensional (3D) space with respect to the x-axis (longitudinal direction), y-axis (transverse direction), and z-axis (height direction). For example, item G1 may be a clothing item, e.g., a hat, that is worn on a mannequin's head and item G2 may be an item that is worn on the mannequin's foot, e.g., a shoe. The item G1 may have an x-axis coordinate of xl, a y-axis coordinate of y1, and a z-axis coordinate of zl, whereas the item G2 has an x-axis coordinate of xl, a y-axis coordinate of y1, and a z-axis coordinate of z2, indicating that the items G1 and G2 are located at the same location on the 2D floorplan but at different heights as the item G1 is at a height of z1 and the item G2 is a height of z2. Each of the locations of the items G1 and G2 may be determined by triangulation, e.g., Delaunay triangulation. For example, a known location of an item G1, G2 may be stored in a database and that location for each of the coordinates (x, y, and z) may be rendered within the 3D environment by triangulating each of the coordinates so that the item G1, G2 may be displayed for the user such that not only is the 2D location of the item G1, G2 with respect to the floorplan located but the height of the item G1, G2 with respect to the floorplan is also located.

With respect to triangulating the location of the item G1, G2, virtual reference points in the 3D environment may be set and the distances of the items G1, G2 with respect to those virtual reference points may be stored in a database such that the intersection of the circular ranges from each of the virtual reference points may be determined so that the location of the items G1, G2 can be readily ascertained while the user navigates through the virtual environment.

In an embodiment, the item G1, G2 may be manipulated and the location in 3D space (x, y, z coordinates) may be updated so that as the user explores the 3D environment or returns to the shopping cart, the item G1, G2 may be readily viewed subsequently when that item is later selected in the shopping cart for viewing.

Each item G1, G2 may be a 3D element that may be tracked within the 3D space for example via camera tracking, which is a process which involves taking a post that has been filmed with a real live camera and tracking it's motion so that 3d elements can be added to it.

This process is used countless times throughout movies and tv shows to add special effects, backdrops, robots, you name it. The items G 1, G2 may be manipulated within the 3D space including repositioning the item and modifying such characteristics as color, for example.

While in one preferred embodiment, the user may first select an item and afterward view the item within a 3D environment, the user may also select items from the 3D environment for placement within a shopping cart for purchase.

As shown in FIG. 4B, an immersive store or experience 106 is displayed on a display 310 of a user device 300. The immersive store or experience 106 may be a 3D simulation of a physical store location. For example, 3D image recordings or captures of actual physical store locations may be made to create a navigable 3D simulated experience. It is to be understood, however, that the 3D simulation may be created and may not represent an actual physical store while still providing the familiarity of a traditional brick-and-mortar shopping experience to the user or customer. The user or customer may navigate the 3D simulation of the immersive store or experience 106 by selecting or clicking on locations L within the displayed image of the immersive store or experience 106. Items that are for sale may be marked with a label I that may be selectable or clickable. Upon selecting a label I, a query to the customer may be generated for adding an associated item(s) with that label I to a shopping cart S and for completing that transaction. Advantageously, the shopping cart and transaction details may be completed from with the immersive store or experience.

A flowchart outlining a method in accordance with the method for providing an immersive shopping experience, as described above, will now be described with reference to FIG. 5. In particular, a method 400 may include at least, but is not limited to the following operations: capturing a plurality of images (402); generating a navigable space based on the plurality of images, the navigable space being an immersive shopping experience, the immersive shopping experience having a floor plan including a plurality of locations (404); associating one or more items for sale with at least one of the plurality of locations, the one or more items for sale being for sale on a merchant e-commerce website (406); presenting the immersive shopping experience to a user computer through the merchant e-commerce website from a third party server (408); receiving a user request to purchase at least one of the one or more items, the user request being generated from within the immersive shopping experience, the request being sent to the third party server from the user computer (410); and updating a shopping cart on the merchant e-commerce website via communication between the third party server and the merchant e-commerce website, the updating of the shopping cart occurring in real-time with the generation of the user request from via the immersive shopping experience (412).

According to various embodiments of the present disclosure, at least a part of the systems, devices, and methods disclosed herein may be implemented with software, firmware, hardware, or any combination thereof. At least a part of the navigation systems, devices, and methods disclosed herein may be implemented (e.g., executed) by a processor. At least a part of the navigation systems, devices, and methods disclosed herein may include, for example, a module, a program, a routine, sets of instructions, or a process for performing at least one function.

The term “module” used herein may represent, for example, a unit including one of hardware, software and firmware or a combination thereof. The term “module” may be interchangeably used with the terms “unit,” “logic,” “logical block,” “component,” and “circuit.” The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific integrated circuit (ASIC) chip, a field-programmable gate array (FPGA), and a programmable-logic device for performing some operations, which are known or will be developed.

At least a part of devices (e.g., modules or functions of the devices) or methods (e.g., operations) according to various embodiments of the present disclosure may be implemented as instructions stored in a computer-readable storage medium in the form of a module. In the case where the instructions are performed by a processor, the processor may perform functions corresponding to the instructions.

A computer-readable storage medium may include a hard disk, a floppy disk, a magnetic medium (e.g., a magnetic tape), an optical medium (e.g., CD-ROM, digital versatile disc (DVD)), a magneto-optical medium (e.g., a floptical disk), or a hardware device (e.g., a ROM, a RAM, a flash memory, or the like). The instructions may include machine language codes generated by compilers and high-level language codes that can be executed by computers using interpreters. For example, an electronic device may include a processor and a memory for storing computer-readable instructions. The memory may include instructions for performing the above-mentioned various methods or functions when executed by the processor. The above-mentioned hardware (e.g., devices) may be configured to be operated as one or more software modules for performing operations of various embodiments of the present disclosure and vice versa.

A module or a program module according to various embodiments of the present disclosure may include at least one of the above-mentioned elements, or some elements may be omitted or other additional elements may be added. Operations performed by the module, the program module, or other elements according to various embodiments of the present disclosure may be performed in a sequential, parallel, iterative, or heuristic way. Furthermore, some operations may be performed in another order or may be omitted, or other operations may be added.

Having described at least one of the preferred embodiments of the present disclosure with reference to the accompanying drawings, it is to be understood that such embodiments are merely exemplary and that the disclosure is not limited to those precise embodiments, and that various changes, modifications, and adaptations may be effected therein by one skilled in the art without departing from the scope or spirit of the disclosure as defined in the appended claims. The scope of the disclosure, therefore, shall be defined solely by the following claims. Further, it will be apparent to those of skill in the art that numerous changes may be made in such details without departing from the spirit and the principles of the disclosure. It should be appreciated that the present disclosure is capable of being embodied in other forms without departing from its essential characteristics.

What is claimed is:

1. A computer-implemented method for an immersive shopping experience, comprising:
capturing a plurality of images;
generating a navigable space based on the plurality of images, the navigable space being an immersive shopping experience, the immersive shopping experience having a floor plan including a plurality of locations;
associating one or more items for sale with at least one of the plurality of locations, the one or more items for sale being for sale on a merchant e-commerce website;
presenting the immersive shopping experience to a user computer through the merchant e-commerce website from a third-party server;
receiving a user request to purchase at least one of the one or more items, the user request being generated from within the immersive shopping experience, the request being sent to the third-party server from the user computer; and
updating a shopping cart on the merchant e-commerce website via communication between the third-party server and the merchant e-commerce website, the updating of the shopping cart occurring in real-time with the generation of the user request from via the immersive shopping experience.

2. The method of claim 1, wherein each of the plurality of locations has a three-dimensional coordinate including an x-axis coordinate, a y-axis coordinate, and a z-axis coordinate.

3. The method of claim 2, wherein the plurality of locations includes a first location and a second location, the x-axis and y-axis coordinates of the first and second locations being the same and the z-axis coordinates of the first and second locations being different.

4. A computer system for implementing an immersive shopping experience, comprising:
a processor;
a tangible, non-transitory method configured to communicate with the processor,
the tangible, non-transitory memory having instructions stored thereon that, in response to execution by the processor, cause the processor to perform operations comprising:
capturing a plurality of images;
generating a navigable space based on the plurality of images, the navigable space being an immersive shopping experience, the immersive shopping experience having a floor plan including a plurality of locations;
associating one or more items for sale with at least one of the plurality of locations, the one or more items for sale being for sale on a merchant e-commerce website;
presenting the immersive shopping experience to a user computer through the merchant e-commerce website from a third-party server;
receiving a user request to purchase at least one of the one or more items, the user request being generated from within the immersive shopping experience, the request being sent to the third-party server from the user computer; and
updating a shopping cart on the merchant e-commerce website via communication between the third-party server and the merchant e-commerce website, the updating of the shopping cart occurring in real-time with the generation of the user request from via the immersive shopping experience.
